(19) United States
(12) Patent Application Publication
(10) Pub. No.: US 2006/0086554 A1
(43) Pub. Date: Apr. 27, 2006

(54) Wheelchair reversible between front wheel drive and rear wheel drive

(75) Inventors: David P. Jackson, Stafford (GB); Peter W. Gillett, Halesowen (GB); Gavin McKinnell, Telford (GB)

Correspondence Address: MACMILLAN SOBANSKI & TODD, LLC;ONE MARITIME PLAZA FOURTH FLOOR, 720 WATER STREET, TOLEDO, OH, 43604-1619, US

(73) Assignee: Sunrise Medical HHG, Inc.

(21) Appl. No.: 11/254,486

(22) Filed: Oct. 20, 2005

Related U.S. Application Data
(60) Provisional application No. 60/620,942, filed on Oct. 21, 2004.
(60) Provisional application No. 60/621,431, filed on Oct. 22, 2004.

(51) Int. Cl. B62D 61/12

(52) U.S. Cl. 180/209; 180/65.1

(57) ABSTRACT

A wheelchair has a base and a seat assembly, the base having drive wheels and caster wheels, the seat assembly being readily removable and replaceable to convert the wheelchair from a rear wheel drive configuration to a front wheel drive configuration, and from a front wheel drive configuration to a rear wheel drive configuration.

### RELATED APPLICATIONS

This application claims priority from U.S. Provisional Patent Application Ser. No. 60/620,942, filed Oct. 21, 2004, and entitled WHEELCHAIR REVERSIBLE BETWEEN FRONT WHEEL DRIVE AND REAR WHEEL DRIVE. This application also claims priority from U.S. Provisional Patent Application Ser. No. 60/621,431, filed Oct. 22, 2004, and entitled WHEELCHAIR WITH TELESCOPIC ANTI-TIP WHEEL.

### TECHNICAL FIELD

This invention relates to power wheelchairs.

### BACKGROUND OF THE INVENTION

Power wheelchairs are equipped with removable batteries to power the wheelchair. Typically, the batteries are removable so that they can be recharged. Also, power wheelchairs are usually one of three varieties, front wheel drive, rear wheel drive, and mid wheel drive.

### SUMMARY OF THE INVENTION

According to this invention there is also provided a wheelchair having a base and a seat assembly, the base having drive wheels and caster wheels, the seat assembly being readily removable and replaceable to convert the wheelchair from a rear wheel drive configuration to a front wheel drive configuration, and from a front wheel drive configuration to a rear wheel drive configuration.

According to this invention there is also provided a wheelchair having a base and a seat assembly, the base having drive wheels and caster wheels, the base having a chassis comprising two longitudinally oriented side rails and two cross tubes. The cross tubes are connected to the side rails to form a substantially rectangular shape. The chassis has down tubes depending downwardly from the side rails, with the down tubes being positioned in a plane substantially transverse to the side rails.

According to this invention there is also provided a wheelchair having a chassis comprising two longitudinally oriented side rails and two cross tubes, the cross tubes being connected to the side rails to form a substantially rectangular shape, the cross tubes being curved at their ends in a substantially horizontal plane, thereby forming a curved anchoring location suitable for tying down the wheelchair during transit of the wheelchair.

According to this invention there is also provided a wheelchair having a base, the base having two drive wheels, two caster wheels and a chassis, the chassis having drive wheel swing arms for supporting the drive wheels relative to the chassis. Each drive wheel swing arm has a link connecting the drive wheel swing arm to a bracket mounted on the chassis, the bracket having multiple connecting points for the link to enable the wheelchair to be configured with drive wheels of different sizes.

According to this invention there is also provided a wheelchair having a drive wheel mounted on a swing arm configured to enable the drive wheel to move relative to a wheelchair frame, and a motor connected to the drive wheel through a gear box, with the gearbox having a disconnect mechanism to enable the drive wheel to be disconnected from the motor. The wheelchair further has a tension link that is operable to disconnect the gearing of the gearbox and thereby disconnect the motor from the drive wheel.

According to this invention there is also provided a wheelchair having a base and a seat assembly, the base having drive wheels and caster wheels. The base has a chassis that includes two longitudinally oriented side rails and two cross tubes, with the cross tubes being connected to the side rails. The chassis also has down tubes depending downwardly from the side rails. The wheelchair further includes a battery box having two compartments, each compartment configured to hold a battery, the two compartments being spaced apart to define a slot between the two compartments, with the down tubes being positioned within the slot.

According to this invention there is also provided a wheelchair having a base, the base having a chassis, and the base having a battery box including two compartments, each compartment configured to hold a battery, the two compartments being spaced apart to define a slot between the two compartments. A battery box is positioned within the chassis, and a wheelchair controller is positioned within the slot.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic perspective view of a wheelchair in a front wheel drive mode.

FIG. 2 is a schematic side view of the base of the wheelchair of FIG. 1.

FIG. 3 is a schematic side view of the base of FIG. 2, with the drive wheel removed.

FIG. 4 is schematic view in perspective of the wheelchair chassis.

FIG. 4A is side elevation view of the wheelchair chassis.

FIG. 5 is a partially cutaway side view in elevation of the wheelchair base showing the battery box.

FIG. 6 is a schematic view in perspective of the battery box.

FIG. 7 is a side view of the battery box.

FIG. 8 is a plan view of the battery box.

FIG. 9 is a schematic perspective view of the seat assembly of the wheelchair.

FIG. 10 is a perspective view of the cog release handle.

FIG. 11 is a schematic view similar to that shown in FIG. 2, but with the cog release handle in a rotated position.

FIG. 12 is a schematic view in elevation of the tension link associated with the cog release mechanism.

FIG. 13 is a schematic view in elevation of one end of the tension link of FIG. 12, showing more detail.

### DETAILED DESCRIPTION OF THE INVENTION

The wheelchair of the invention has a base and a seat assembly, the seat assembly being readily removable and replaceable to convert the wheelchair from rear wheel drive configuration to a front wheel drive configuration, and from a front wheel drive configuration to a rear wheel drive configuration.

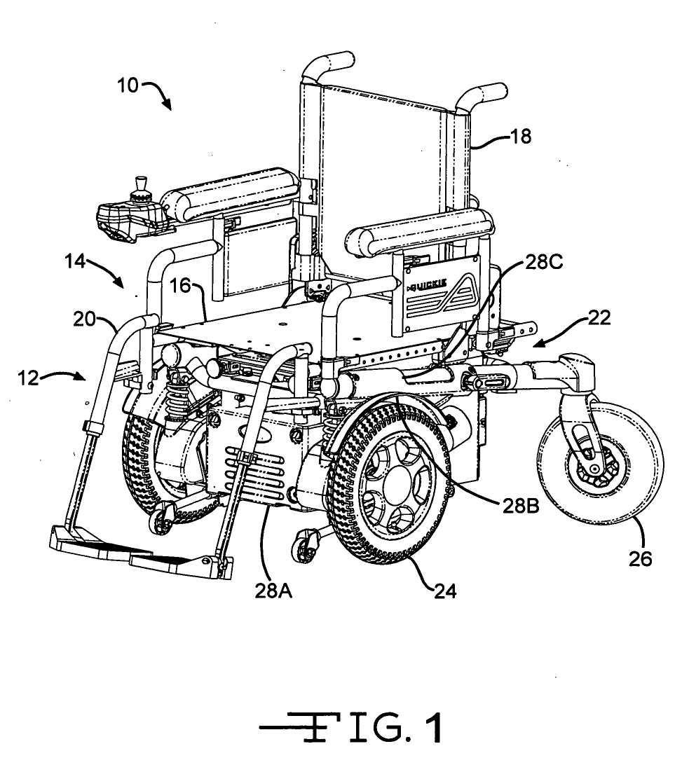

As illustrated in FIG. 1, the wheelchair, indicated generally at 10, includes a base 12 and seat assembly 14. The seat assembly includes a seat 16, a seat back 18, and optional leg rests 20. The base 12 includes a chassis 22, drive wheels 24 and caster wheels 26.

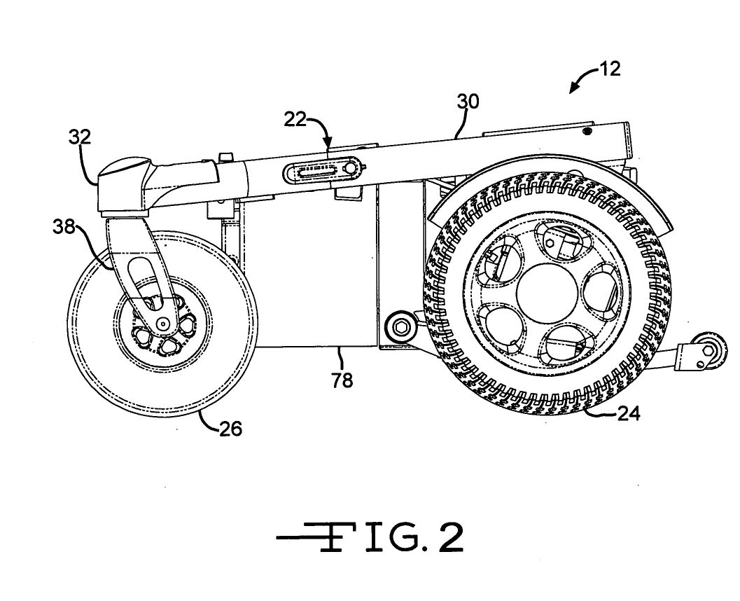

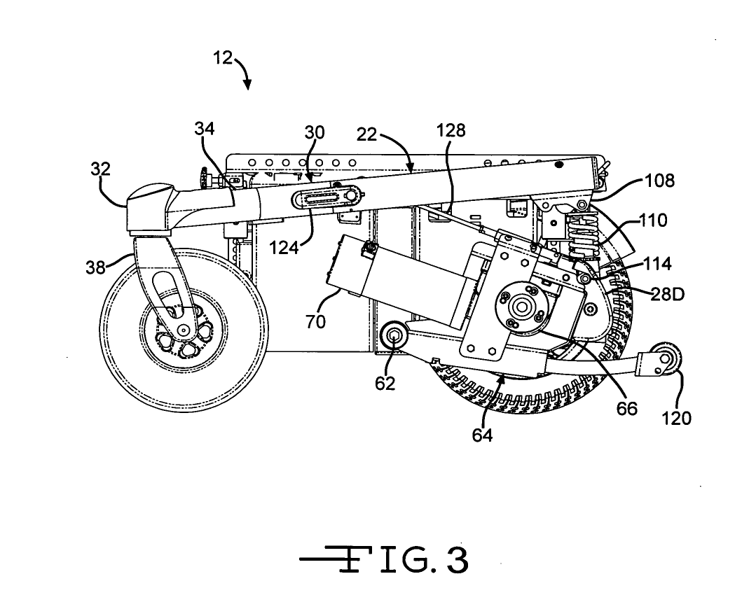

As shown in FIGS. 2 and 3, the chassis 22 includes side rail 30 having a caster housing or caster boss 32 at one end 34 of the side rail 30. The caster boss 32 provides a socket or mounting for a stem of a caster fork 38, which mounts the caster wheel 26. The caster fork 38 is free to rotate about the stem, which is aligned on a vertical axis. For decorative purposes as well as functional reasons, the wheelchair is optionally provided with removable shrouds, such as front shroud 28A, drive wheel shroud 28B, side rail shrouds 28C, all shown in FIG. 1, and rear shroud 28D, shown in FIG. 3.

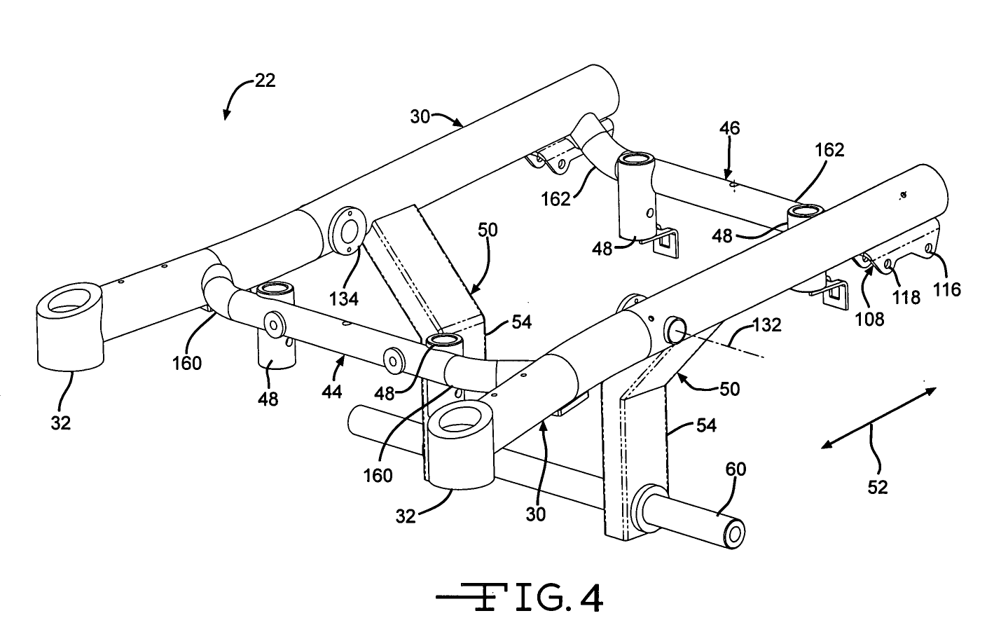

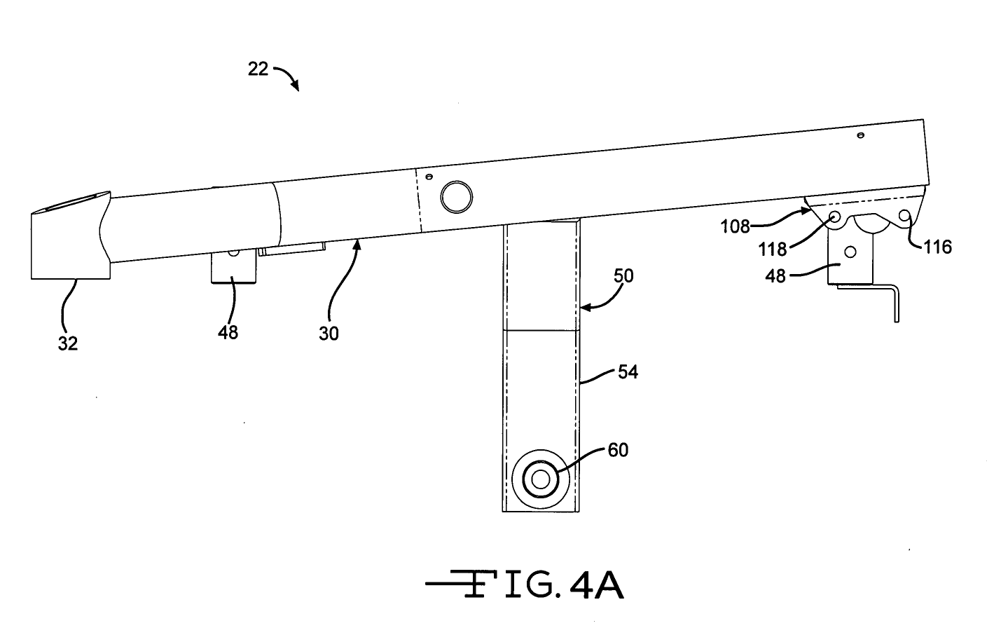

As shown in FIGS. 4 and 4A, the chassis 22 includes a pair of substantially parallel side rails 30 joined by cross tubes 44 and 46, respectively. The side rails 30 and cross tubes 44 and 46 can be of any suitable shape and construction. In the embodiment shown, the rails and tubes are of welded steel. The cross tubes 44 and 46 each contain a pair of seat mount sockets or bosses 48. These are welded to the cross tubes 44 and 46, although any means of attachment can be used. The seat mount sockets or bosses 48 are configured to receive the posts of a seat frame, not shown in FIG. 4, and thereby provide a mounting system for the wheelchair seat assembly 14. The spacing between the two seat mount bosses 48 on cross tube 44 is the same as the spacing between the two seat mount bosses 48 on cross tube 46. This feature enables the chassis 22 to receive the seat assembly 14 in either a front wheel drive or rear wheel drive orientation, depending on the desired configuration. The seat assembly 14 can be readily removed from the chassis 22, turned 180 degrees, and placed back on the chassis 22.

The chassis 22 also includes axle mounting down tubes 50 that depend downwardly from the side rails 30. Preferably, the down tubes 50 are positioned in a lateral plane substantially transverse to the side rails 30, with the side rails being oriented in a substantially longitudinal forward/rearward direction, as indicated by the directional arrow 52. It can be seen that the side rails 30 and the cross tubes 44 and 46 form a generally rectangular shape when viewed from above, although other configurations are possible. The down tubes 50 lie in a plane that is substantially transverse to the side rails 30, and that substantially bisects the rectangle. Preferably, the down tubes 50 are curved inwardly as they extend downwardly. This helps in making the track width or spacing between drive wheels as narrow as possible.

At or near the lower end 54 of the down tubes 50 are pivot bar mounting orifices 56 for mounting the pivot bar 60. The pivot bar 60 is at the pivot point 62 for a motor swing arm 64, as shown in FIGS. 2 and 3. The swing arm 64 includes a gear box 66 that is fixed to the swing arm 64 by bolting or any other suitable fastening mechanism. Mounted to the gearbox 66 is a drive motor 70. The drive wheel 24 is mounted to the gear box 66. The swing arm 64 enables the drive wheel 24 to move up and down relative to the chassis 22, and the swing arm pivots at pivot point 62.

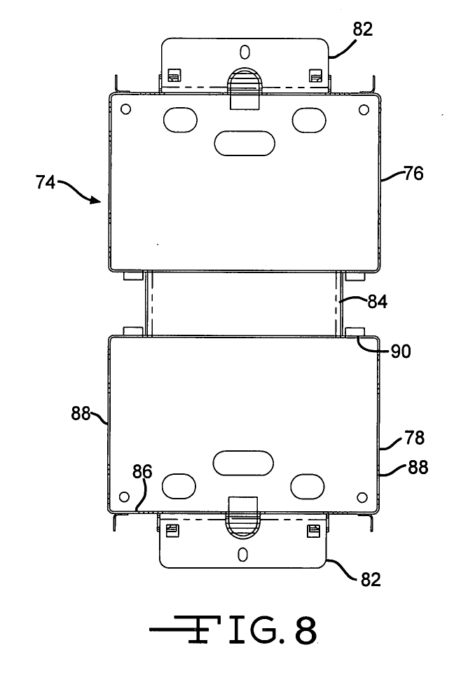

As shown in FIG. 9, the seat assembly 14 includes 4 seat posts 91 that are configured to be inserted into the four seat bosses 48 of the chassis 22 to mount the seat assembly 14 to the wheelchair base 12. The posts 91 are attached to the seat frame 92 by anchoring brackets 93, although other means of attaching the seat posts 91 to the frame can be used. The seat frame 92 includes a pair of longitudinally oriented seat members 94, and two or more cross members 95. It is to be understood that the elements of the seat assembly can be made of tubular aluminum members, and can be welded together, but the these elements can also be made of other materials, and can be joined with different techniques. The posts 91 have an array of orifices 96 that allow the posts to be positioned at selected heights with respect to the base 12 and seat bosses 48 to enable the seat assembly 14 to be mounted at a desired height and pitch with respect to the base 12.

The seat frame 92 is pivotally mounted at its rear end 97, and is latched in place at the front end by locking knobs 99 which are inserted into the anchoring brackets 93. When it is desired to lift up the seat assembly 14 to access the batteries, the locking knobs 99 are withdrawn from the anchoring brackets 93, and the front of the seat assembly 14 is lifted up. It is to be understood that numerous other mechanisms can be used to removably attach the seat assembly 14 to the wheelchair.

Optionally, the seat assembly 14 is provided with a seat stay 100 that can be used to hold the seat frame 92 in an open or lifted position. The seat stay can be of any configuration, such as that shown in FIG. 9, where the seat stay 100 is pivotally mounted in a rose bearing 102. The rose bearing 102 is attached to the frame 92 at pivot point 104, enabling the rear end 106 of the seat stay 100 to be freely moved about. The seat stay 100 is normally stowed by insertion in a spring clip 108 attached to the frame 92 at bracket 110. The seat stay rear end 106 is hook-shaped, and when the front end of the seat assembly is lifted up, and the rear end 106 of the seat stay 100 is pivoted down, the stay rear end 106 can be inserted into orifice 112 in the post 91. This will temporarily prop up or brace the front end of seat frame 92 in an upright or raised condition. Other mechanisms can be used to temporarily hold the raised seat frame 92 in a raised position.

Optionally, the seat stay 100 can be provided with a safety cap 114 that is mounted for sliding along the seat stay 100. The safety cap 114 can be made of any suitable material, such as a resilient elastomeric material. When the seat stay 100 is engaged with the seat post 91 by inserting the rear end 106 into the orifice 112, the safety cap 114 can be slid down along the seat stay 100 until the cap 114 engages the top of the post 91. With the safety cap 114 snapped onto the post 91, the seat stay 100 cannot be inadvertently pulled out of the orifice 35 U.S.C. §112, second paragraph. Unexpected disengagement of the seat stay 100 from the post could injure someone replacing a battery, and the use of the safety cap 114 can prevent this. Other safety devices can also be used.

It can be seen that the wheelchair 10 can be changed from a front wheel drive arrangement to a rear wheel drive arrangement by removing the seat assembly 14 and seat posts 91 from the seat mount sockets 48, reversing the seat from front to rear, and inserting the seat posts 91 back into the seat mount sockets 48. Alternatively, the seat assembly can be reversed by disconnecting the seat posts 91 from the anchoring brackets 93, lifting the seat assembly 14 away from the wheelchair base 12, reversing the seat assembly 14 from front to rear, and inserting the seat frame 92 back onto the seat posts 91. The anchoring brackets 93 or the longitudinally oriented seat members 94 can be provided with a plurality of orifices to allow bolting the respective members together in a desired forward and rearward position. Other possible means for attaching the seat assembly 14 to the wheelchair base 12 include using either a dummy interface plate, not shown, or a tilt adjusting plate, not shown, or both a dummy interface plate and a tilt adjusting plate. Further, lift and tilt modules, not shown, can also be used.

It is to be understood that the seat assembly 14 can have any configuration suitable for seating the wheelchair occupant. A desired attribute for the wheelchair is that the seat assembly can be reversed without the use of tools, thereby enabling easy conversion of the wheelchair from a front wheel drive wheelchair to a rear wheel drive wheelchair, and vice versa, and without requiring other components to be changed. Therefore, the seat assembly 14 is readily removable and replaceable in a different orientation to convert the wheelchair from a rear wheel drive configuration to a front wheel drive configuration, and from a front wheel drive configuration to a rear wheel drive configuration. Although it is desirable to be able to convert from front wheel drive to rear wheel drive, and from rear wheel drive to front wheel drive, without using tools, in some embodiments of the invention, tools may be required.

As shown in FIGS. 3, 4 and 4A, the chassis 22 includes an adjuster bracket 108 for accommodating the use of drive wheels of two different sizes. A suspension spring/rigid link 110 is connected between the adjuster bracket 108 and a link bracket 114 on the swing arm 64. The suspension spring/rigid link 110 can be moved to either of the two connector orifices 116 and 118 on the adjuster bracket 108 as desired to accommodate changes in the size of the drive wheel 24. For example, for a 14 inch diameter drive wheel, the connector orifice 116 in the bracket 108 can be used, whereas for a 16 inch drive wheel, the connector orifice 118 can be used. A desired attribute for the wheelchair is that the drive wheel 24 can be changed from one size to another as desired without necessitating the changing of other components. For example, the drive wheel can be changed from a 13 inch drive wheel to a 14 inch drive wheel.

FIG. 5 shows a rear anti-tip wheel 120 mounted to minimize the possibility of having the wheelchair 10 tip backwards when the wheelchair is in a rear wheel drive configuration. The anti-tip wheel 120 is optionally mounted onto the swing arm 64 as shown in FIG. 3. Other mounting mechanisms and locations can be used. One of the advantages of the chassis configuration of the wheelchair base 12 is that the cross tubes 44 and 46 form a good anchoring location for connections frequently used in tying down wheelchairs in a transit situation on vehicles such as vans and busses. Typically the tie down apparatus for such transport is a set of straps that are connected to the wheelchair by means of carabiners. As shown in FIG. 4, in a substantially horizontal plane the curvature of the cross tubes 44 and 46 at their ends 160 and 162, respectively, and the relatively short tube space between the bosses 48 and the weld points where the cross tubes 44 and 46 are welded to the side rails 30, offer an ideal attachment point for the carabiners, or for other suitable attachment devices. It can be seen that the curvature of the cross tubes at their ends is in a substantially horizontal plane, thereby forming a curved anchoring location suitable for tying down the wheelchair during transit of the wheelchair.

It can also be seen that these exposed portions of the cross tubes are easily accessible both at the front and the rear of the wheelchair. Further, they provide a defined zone of attachment of an appropriate size (i.e., length and diameter) for typical carabiner attachment devices, and eliminate the need for separate tie down brackets. The cross tubes 44 and 46 present attachment locations that do not require any additional brackets or hardware for connecting tie down straps, and do not require any changes to the wheelchair. Optionally, the cross tubes 44 and 46 are substantially symmetrical, and therefore the front end is the same as the rear end. In summary, each of the cross tubes is provided with two vertically oriented bosses configured to receive posts for a seating assembly, and the curved anchoring location is defined as the portion of the cross tube between one of the bosses and the connection of the end of the cross tube with the side rail.

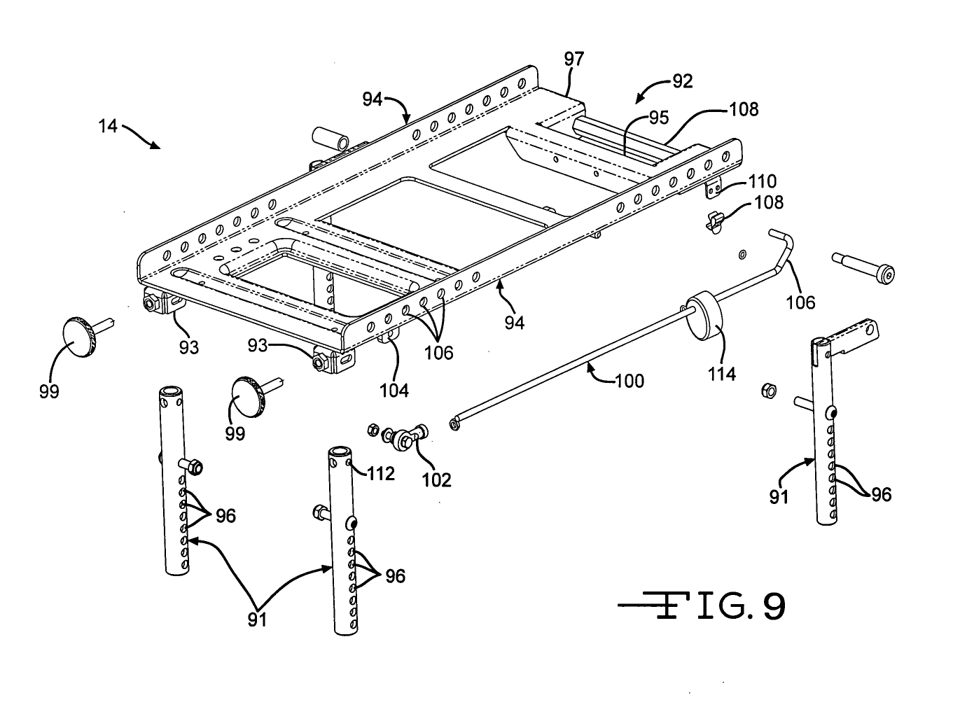

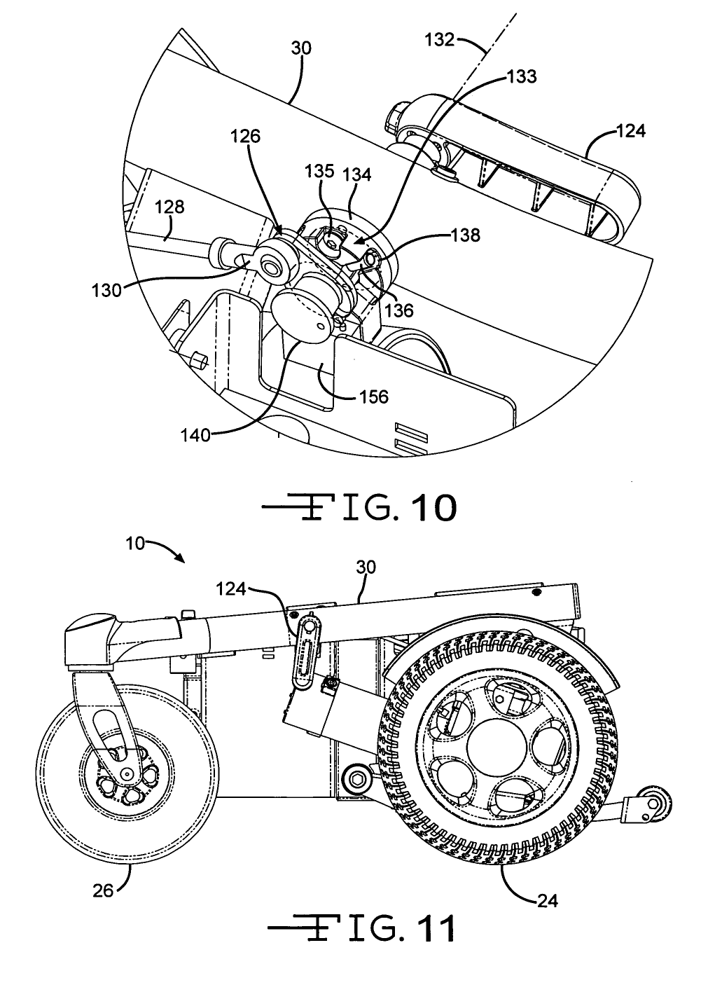

The wheelchair 10 is preferably provided with a cog release mechanism associated with the gearbox 66 to enable the wheelchair user to disconnect the gearing and allow the wheelchair to become freewheeling. As shown in FIGS. 3 and 10, a handle 124 is connected to a cam or lever 126 so that rotation of the handle 124 rotates the lever 126. The lever is connected to a tension link 128 by means of a pivotal connection 130. The tension link 128 is connected to the gearbox 66, and by pulling on the tension link 128, the cog release is operated. This results in releasing the gearing to the motor, and the wheelchair becomes freewheeling.

The handle 124 and lever 126 are mounted through the chassis side rail 30 to rotate about axis 132, shown in FIG. 4. The cog wheel release mechanism is configured so that the handle 124 must be both rotated about the rotational axis 132 and moved laterally inward, axially along the rotational axis 132, in order to effect a change in the cog release mechanism. This requirement of two different degrees of motion is a safety feature, assuring that the motor will not inadvertently become disengaged. FIG. 11 shows the handle 124 in the rotated position, indicating that the gearing is disconnected.

As shown in FIGS. 4 and 10, a cog wheel 133 is fixed to the chassis side rail 30 at a pivot point 134. The cog wheel can be fastened in any manner, such as with a bolt 135. A cross shaft, not shown, oriented along the pivot axis 132, connects the handle 124 with the lever 126, so that they rotate in unison. The cross shaft has a radially projecting pin 136 that can be moved into any one of two or more receptor slots 138 in the cog wheel 133. Only one receptor slot is shown in FIG. 10 because the other receptor slot is hidden from view, in a clockwise direction as shown in FIG. 10. The pin 136 is biased toward the cog wheel 133 by means of a spring, not shown, but located beneath cap 140, so that rotation of the handle 124 and lever 126 requires a force axially along the axis 132 to enable the pin to be removed from its receptor slot to a different receptor slot. This provides two degrees of movement since the handle 124 must be both pushed in and rotated to disengage the gearing. Further, the spacing between the receptor slots 138 allows the handle to rotate to a specified angle, thereby rotating the lever 126 a predetermined distance. The angle of rotation allowed for the rotation of the handle 124 and lever 126 can be any angle suitable to operate the cog release mechanism. In a specific embodiment, the angle is about 70 degrees.

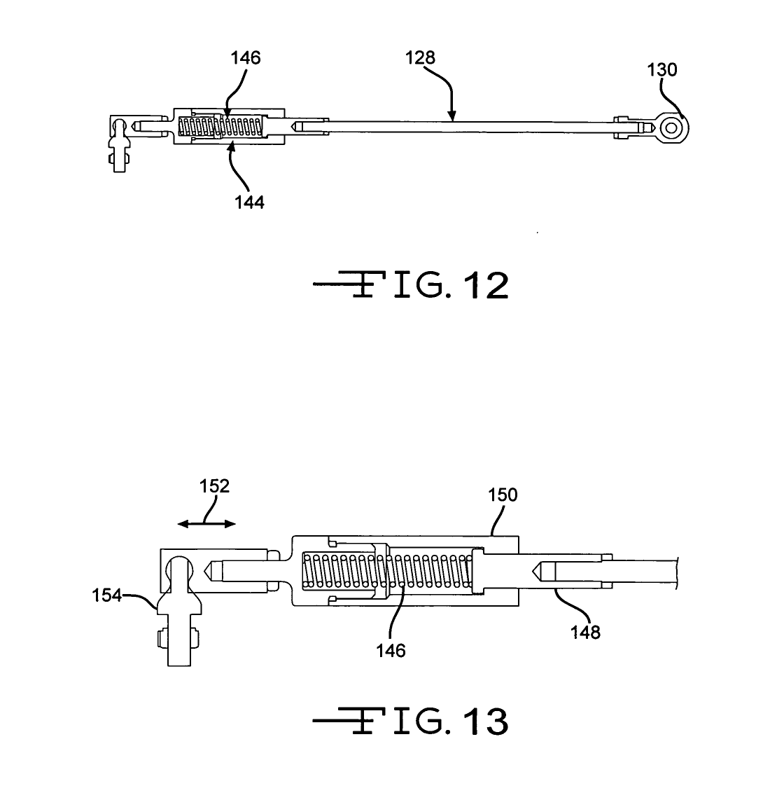

As shown in FIGS. 12 and 13, the tension link 128 is preferably provided with a compensator mechanism 144, which consists of a spring 146 mounted within the tension link 128 to allow the drive wheel 24 and pivot arm 64 to move up or down without causing the cog release mechanism to become activated (and thereby causing accidental disengagement of drive force to the drive wheel 24). A slider 148 is positioned to be movable within a barrel 150 causing the spring 146 to compress as the drive wheel 24 and pivot arm 64 move, which is shown schematically by directional arrow 152. When the handle 124 is rotated to enter the freewheel mode, the tension link 128 is pulled, the slider 148 is pulled to the end of the barrel 150, and the tensile force is transmitted through the tension link 128 to the cog release shaft 154 to disengage the gearing. When the lever 126 is rotated about axis 132 clockwise as shown in FIG. 10, a portion of the lever 126 will impinge on a switch 156, thereby sending a signal to the controller that the gearing is in a disconnected mode.

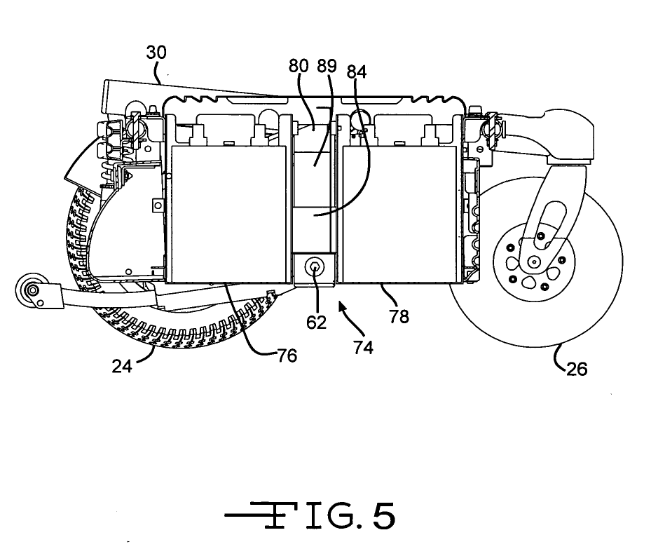

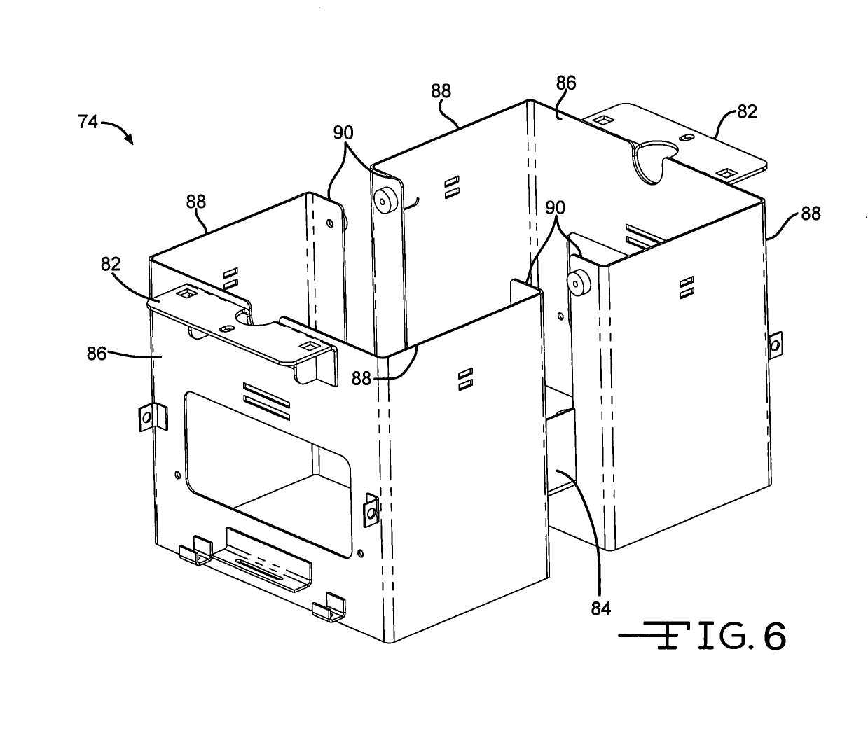

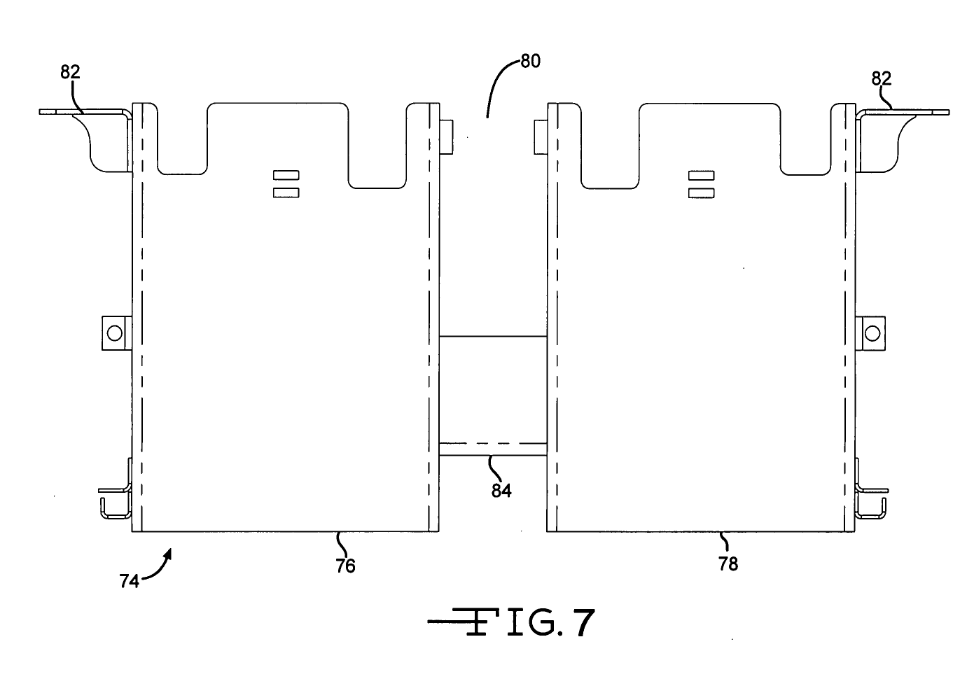

As shown in FIG. 5 the wheel chair 10 includes a battery box 74. The battery box is divided into two compartments 76 and 78 with a gap or slot 80 positioned between the two compartments. As shown in FIGS. 6-8 each compartment 76 and 78 includes an attachment flange 82. The attachment flange is used to attach the battery box 74 to the cross tubes 44 and 46. A battery box connector 84 structurally connects the two compartments 76 and 78 to each other. The battery box connector 84 can be any structural member suitable for connecting the two compartments. Each compartment 76 and 78 includes a front face 86, a side face 88 and rear flanges 90 to contain a battery, not shown. The battery box is generally maintained in place, mounted to the chassis 22, although it can be removed. The batteries can be removed from each compartment 76 and 78 as necessary. Preferably the batteries are charged in place with an onboard charger, not shown. It can be seen that the batteries are longitudinally spread out, one being forward of the drive wheel pivot point 62, and one being rearward. Preferably, the batteries are equally spaced from the drive wheel pivot point 62.

One of the advantages of the design of the battery box 74 is that the slot 80 can be used to mount a controller 89, as shown in FIG. 5 for controlling the operation of the wheelchair 10. A desired attribute for the wheelchair is that the controller be mounted centrally. Preferably the controller 89 is mounted between the two battery box compartments 76 and 78. The controller can be mounted on a bracket, not shown, and installed within the slot 80. The advantage in having the controller mounted centrally of the wheelchair, between the two battery box compartments 76 and 78, is that when the wheelchair is reconfigured from a front wheel drive wheelchair to a rear wheel drive wheelchair, the communications wiring from the controller 89 to various controlled elements, such as the motors 70, need not be reconfigured. Also, the length of any connection from the controller 89 to any manual controls, such as a joy stick, or other functional or structural elements mounted on the wheelchair seat assembly 14 will be minimized regardless of the orientation of the seat assembly, i.e., regardless of whether the wheelchair is configured as a front wheel drive or rear wheel drive wheelchair. An additional aspect of providing the slot 80 between the two battery compartments 76 and 78 is that the battery box 74 can fit over the axle mounting down tubes 50. This interconnection between the slot 80 and the down tubes 50 provides an automatic locator when installing the battery box 74 into the chassis 22. Also, the controller 89 is in a protected position.

The principle and mode of operation of this invention have been described in its preferred embodiments. However, it should be noted that this invention may be practiced otherwise than as specifically illustrated and described without departing from its scope.

What is claimed is:

1. A wheelchair having a base and a seat assembly, the base having drive wheels and caster wheels, the seat assembly being readily removable and replaceable to convert the wheelchair from a rear wheel drive configuration to a front wheel drive configuration, and from a front wheel drive configuration to a rear wheel drive configuration.

2. The wheelchair of claim 1 in which the seat assembly includes seat posts, and the base includes a chassis having cross tubes containing bosses configured to receive the posts in either a front wheel drive or rear wheel drive configuration.

3. The wheelchair of claim 2 in which the chassis includes two of the cross tubes, with each cross tube having two of the bosses, where the spacing between the bosses on one of the cross tubes is substantially equal to the spacing between the bosses on the other cross tubes.

4. The wheelchair of claim 1 in which the readily removable and replaceable seat assembly can be removed and replaced without the use of tools.

5. A wheelchair having a base and a seat assembly, the base having drive wheels and caster wheels, the base having a chassis comprising two longitudinally oriented side rails and two cross tubes, the cross tubes being connected to the side rails to form a substantially rectangular shape, the chassis also having down tubes depending downwardly from the side rails, the down tubes being positioned in a plane substantially transverse to the side rails.

6. The wheelchair of claim 5 in which the down tubes are positioned in a plane that substantially bisects the rectangular shape of the chassis.

7. The wheelchair of claim 5 in which down tubes have lower ends that support a pivot bar configured to pivotally support drive wheel swing arms, upon which the drive wheels are mounted.

8. A wheelchair having a chassis comprising two longitudinally oriented side rails and two cross tubes, the cross tubes being connected to the side rails to form a substantially rectangular shape, the cross tubes being curved at their ends in a substantially horizontal plane, thereby forming a curved anchoring location suitable for tying down the wheelchair during transit of the wheelchair.

9. The wheelchair of claim 8 in which each of the cross tubes is provided with two vertically oriented bosses configured to receive posts for a seating assembly, and in which the curved anchoring location is defined as the portion of the cross tube between one of the bosses and the connection of the end of the cross tube with the side rail.

10. A wheelchair having a base, the base having two drive wheels, two caster wheels and a chassis, the chassis having drive wheel swing arms for supporting the drive wheels relative to the chassis, each drive wheel swing arm having a link connecting the drive wheel swing arm to a bracket mounted on the chassis, the bracket having multiple connecting points for the link to enable the wheelchair to be configured with drive wheels of different sizes.

11. The wheelchair of claim 10 in which the bracket has two connecting points.

12. The wheelchair of claim 10 including a suspension spring connected between the bracket and the drive wheel swing arm.

13. A wheelchair having a drive wheel mounted on a swing arm configured to enable the drive wheel to move relative to a wheelchair frame, and a motor connected to the drive wheel through a gear box, with the gearbox having a disconnect mechanism to enable the drive wheel to be disconnected from the motor, the wheelchair further having a tension link that is operable to disconnect the gearing of the gearbox and thereby disconnect the motor from the drive wheel.

14. The wheelchair of claim 13 in which the tension link includes a compensator mechanism to allow the drive wheel to move relative to the frame without disconnecting the gearing of the gearbox.

15. The wheelchair of claim 14 in which the compensator mechanism includes a spring mounted within the tension link.

16. The wheelchair of claim 13 in which the tension link is connected to a rotatably mounted lever, wherein rotation of the lever applies tension to the tension link and disengages the gearing of the gearbox.

17. The wheelchair of claim 16 in which rotation of the lever operates a switch, thereby sending a signal to a controller that the gearing is in a disconnected mode.

18. A wheelchair having a base and a seat assembly, the base having drive wheels and caster wheels, the base having a chassis that includes two longitudinally oriented side rails and two cross tubes, the cross tubes being connected to the side rails, the chassis also having down tubes depending downwardly from the side rails, the wheelchair further including a battery box having two compartments, each compartment configured to hold a battery, the two compartments being spaced apart to define a slot between the two compartments, with the down tubes being positioned within the slot.

19. The wheelchair of claim 18 in which the seat assembly is readily removable and replaceable to convert the wheelchair from a rear wheel drive configuration to a front wheel drive configuration, and from a front wheel drive configuration to a rear wheel drive configuration.

20. A wheelchair having a base, the base having a chassis, and the base having a battery box including two compartments, each compartment configured to hold a battery, the two compartments being spaced apart to define a slot between the two compartments, with the battery box being positioned within the chassis, and with a wheelchair controller positioned within the slot.
